(19) United States
(12) Patent Application Publication
(10) Pub. No.: US 2007/0244752 A1
(43) Pub. Date: Oct. 18, 2007

(54) SYSTEM AND METHOD FOR THE INTEGRATED DISTRIBUTION OF ADVERTISING VIA THE INTERNET AND MOBILE TERMINALS

(76) Inventor: Anthony Jeremiah Bayne, Lomita, CA (US)

Correspondence Address: ANTHONY JEREMIAH BAYNE, 25315 ANDREO AVENUE, LOMITA, CA, 90717, US

(21) Appl. No.: 11/428,598

(22) Filed: Jul. 5, 2006

Related U.S. Application Data
(60) Provisional application No. 60/792,495, filed on Apr. 17, 2006.
(60) Provisional application No. 60/801,695, filed on May 20, 2006.
(60) Provisional application No. 60/809,191, filed on May 30, 2006.

(51) Int. Cl. G06Q 30/00

(52) U.S. Cl. 705/14

(57) ABSTRACT

A system and method for providing a mobile terminal user a rebate for the charge of a call when the user views an advertisement after the completion of the call. The user may have to view the advertisement within a specified time following the call established by the system administrator and respond to a question about the advertisement in order to earn a full or greater rebate. Viewing the advertisement may be done on the user's mobile terminal's LCD, or via an Internet enabled PC. Users who choose the latter, may access the advertisement by clicking on a hyperlink sent to them via email, or by accessing the service provider's website using a unique user PIN to login. Service providers select advertisements based on factors including location, day, time, and the user's demographic and personal interests. In a prepaid system, prepaid users may have their accounts conditionally debited pending the viewing of an advertisement.

### RELATED APPLICATION

This application claims the benefit of priority to the U.S. Provisional Application Ser. No. 60/792,495 filed Apr. 17, 2006, 60/801,695 filed May 20, 2006 and 60/809,191 filed May 30, 2006. Each of the foregoing applications is hereby incorporated by reference in its entirety.

### BACKGROUND OF THE INVENTION

1. Field of the Invention

The present invention relates to subsidizing a call made on a mobile terminal, and more particularly to allowing a mobile user to have his mobile account conditionally charged, or conditionally debited in the case of a prepaid user, for a call made or received, and then have the conditional charge or debit rebated for viewing an advertisement either on a display of the mobile terminal or on a computer having access to the Internet.

2. Description of the Related Technology

A Mobile Virtual Network Operators (MVNO) is a company (e.g. Helio) that resells wireless services of other mobile phone providers (e.g. Sprint-Nextel) under their own name. MVNO's target niche markets by offering unique content, state-of-the-art mobile phones, prepaid or subsidized calling. MVNO subscribers (users) may be billed for services, or prepay for services.

Many MVNO users have mobile phones that are multimedia messaging service (MMS) enabled that can access the Internet via various wireless protocols (e.g. wireless access protocol (WAP), i-Mode, etc.) to download data “content” from websites over various “third generation” (3G) (global system for mobile communications) based high speed data networks (e.g. “EDGE”—Enhanced Data Rates for GSM Evolution). Content may include advertisements.

Mobile phone service providers who provide the infrastructure to the MVNO are able to “track” the identity and position of a user via a subscriber identity module (SIM) card and various location based technologies (e.g. Global positioning system (GPS)) to deliver advertising that is relevant to the user's location. Many of these user's additionally have access to the Internet via a computer (e.g. a personal computer “PC”), their own, or one shared with others, on which they can access Internet websites.

An MVNO may offer subsidized calling to a user in exchange for the user viewing one or more advertisements a day. For instance, in United States patent U.S. Pat. No. 6,647,257, Owensby teaches a system and method whereby users receive free or discounted talk time in exchange for viewing “targeted messages” (advertisements) based on a combination of unique user information (“Subscriber Profile Data”), “Historical Response Data”, as well as “Wireless Mobile Location Data” before or during a mobile call.

A problem with the prior art is that requiring the user to view a targeted messages (advertisements) “before and during a wireless communication” may be inconvenient or unsafe (e.g. while driving). Additionally, the advertiser is not likely to have a user's undivided attention in public. Further, it is disruptive to a conversation to hear or view advertisements “during” a call. Therefore, there remains a need to allow the user to view a advertisement at a more convenient time, or in a more convenient location, while still subsidizing the mobile call.

Another problem with the prior art is that the user may be in a public place while viewing a advertisement, and though the user may want to make a purchase of an item or service shown, there may be a lack of privacy (e.g. user is on a bus) for use of a credit card to make a purchase.

Yet another potential problem with the prior art is that by having a user perform a service, namely to view advertisements in exchange for “free” airtime, may create a taxable event (income) to the user. The income being the market value of the “earned” talk time. Therefore there remains a need to present advertising to a user that is convenient protects the user's privacy, and does not trigger a taxable event.

### SUMMARY OF CERTAIN INVENTIVE ASPECTS

The system and method of the invention each have several aspects, no single one of which is solely responsible for its desirable attributes. Without limiting the scope of this invention as expressed by the claims that follow, its more prominent features will now be discussed briefly. After considering this discussion, and particularly after reading the section entitled “Detailed Description of Certain Embodiments” one will understand how the features of this invention provide advantages that include providing a way of improving the efficiency of mobile telephony, and providing a way of making available for viewing advertising that is convenient and relevant to the mobile user.

One embodiment is a method of providing advertisements to a prepaid user of a mobile terminal of a prepaid mobile communications system. The method includes identifying the mobile terminal utilized by said prepaid user, determining whether a sufficient credit balance exists on the prepaid user's account to make or receive a call. The method further includes, if the account has a sufficient credit balance, prompting the prepaid user to choose to have the call subsidized by viewing an advertisement after the call. The method further includes, if the prepaid user chooses to have the call subsidized, selecting an advertisement, making or receiving the call, and making the advertisement available for viewing after the call.

Another embodiment is a method of providing an advertisement to a user of a mobile terminal of a mobile communications system. The method includes identifying the mobile terminal of a user and prompting the user to choose to have a call subsidized by viewing an advertisement after the call is made or received by the user. The method further includes, if the user chooses to subsidize the call, selecting the advertisement, and making or receiving the call. The method further includes making the advertisement available to the user for viewing after the call.

Another embodiment is a system for providing a subsidized call to a user of a mobile terminal. The system includes a means for identifying a mobile terminal of a user, means for providing said user an option to view an advertisement after a call is made or received by said user. If the user chooses to view an advertisement after the call, means for selecting at least one advertisement and conditionally charging the user's mobile account for the call. The system further includes a means for making the advertisement available for viewing by the user after the call, and storing data indicative of whether the user views the advertisement. If the system receives data indicative of the user viewing the advertisement, a means for rebating the user's mobile account based on said data indicative of viewing.

Another embodiment is a system for providing subsidized calls to a user of a mobile terminal. The system includes a server configured to identify a mobile terminal of said user, and provide said user an option to view an advertisement after a call is made or received by said user. If the user chooses to view an advertisement after the call is made or received, select at least one advertisement. The system further includes conditionally charging the user's mobile, and providing said user an opportunity to view the advertisement after the call. The server rebates the user's mobile account based on a receipt of data indicative of viewing. The system further includes a database configured to receive and store data indicative of whether the user views the advertisement.

### BRIEF DESCRIPTION OF THE DRAWINGS

FIG. 1 is a block diagram illustrating an exemplary system in accordance with certain embodiments of the present invention.

FIG. 2, comprising FIG. 2a and FIG. 2b, are flowcharts illustrating an exemplary method for a subsidizing a call in accordance with certain embodiments.

### DETAILED DESCRIPTION OF CERTAIN EMBODIMENTS

The following detailed description is directed to certain specific embodiments of the invention. However, the invention can be embodied in a multitude of different ways as defined and covered by the claims. In this description, reference is made to the drawings wherein like parts are designated with like numerals throughout.

The present invention solves the aforesaid problems by providing a mobile phone user a time-shifted viewing option of advertisements, the viewing of which will result in the service provider rebating a charge or debit to the user's account for the call. In some embodiments the viewing must be done within a fixed duration after the call, or may require the user responding to a question after viewing the advertisement. More particularly, the invention is a system and method that allows a user to view advertisements (either on the mobile terminal or via an internet enabled PC) after completing (making or receiving) a call, to qualify for a rebate on charges for call service or to earn other incentives (e.g. credits toward content).

Further, the invention, by providing a system and method that is a permission based, voluntary advertising scheme that addresses the user's interests, based on the user's answers given in the questionnaire/service application, sponsor advertiser's have a greater probability of obtaining a new customer.

Embodiments may be used to establish a new revenue stream for participating mobile phone service providers (and client MVNOs) by receiving money from sponsoring advertisers for making their advertisements viewable to the user. The user will also benefit by earning rebates calling charges. Presently, because of the relative size of the screens and processing power of mobile phones in compared to a typical PC, advertising viewed on a terminal's LCD will have a diminished impact on the viewer. The disclosed invention provides the user a time shifted viewing option that allows the viewing of an advertisement via another venue (PC) other than the mobile terminal's LCD. In the case of a user not having access to an internet enabled PC, the invention at least allows the user to view a advertisement on the mobile terminal at later time, when it may be more convenient than “before or during a call”. In this way the advertiser will have a better chance of getting the user's undivided attention, and the user has viewing option convenience and privacy. In addition to having charges for the call rebated, the user may receive other incentives such as credits toward content.

Embodiments include an apparatus, system and method for sending advertising content, via a wireless transport protocol (e.g. WAP) over a telecommunications network, to an MS enabled mobile terminal having a liquid crystal display (LCD) to display the content. The embodiments include an Internet enabled PC that the user can access to view advertisements on after a mobile call is completed, either by logging into a service provider or sponsoring advertiser's website directly to view an advertisement, or in another embodiment, the user may follow a hyperlink that the user received by emailed to an advertisement. The mobile user may have a billed, or a prepaid mobile account. A user who chose to have a call subsidized after a call is made or received will have any charge conditionally made against his account for the call rebated, if the user views the advertisement, either on the terminal or PC, within the duration fixed by the system administrator.

Although the following description of exemplary embodiments of a wireless handset device will be presented in the context of a “terminal”, it should be understood that the description may also be applicable to other embodiments such as Smart phones, phone enabled PDAs, Pocket PC's and laptops that are VOIP enabled, as well as other mobile devices that have access to the internet and MMS capabilities. Thus, the term “terminal” as used herein should be broadly construed as to encompass any type of mobile device that is capable of downloading multi media content and displaying that content as described herein.

Likewise, although the following description of exemplary embodiments of a computer being internet enabled in the context of a “PC”, it should be understood that the description may also be applicable to other embodiments such as a MAC, Pocket PC's and laptops that are internet enabled, as well as other devices that have access to the internet and MMS capabilities. Thus, the term “PC” as used herein should be broadly construed as to encompass any type of computer device that is capable of downloading multi media content and displaying that content as described herein.

In a preferred embodiment a user of the service will fill out a brief questionnaire that can be part of the wireless application for service, including user demographic (annual income range, home or work zip code, age range), and user interests (e.g. dining, movies, music). Interests can be further defined by genre (BBQ, horror, blues), or locations of where the user actually pursues these interests (Lucille's, Cineplex 9, Best Buy). The user may receive greater rebates, or other incentives, for providing more detailed information (e.g. date of birth) in the questionnaire. In one embodiment, the user may have to have a valid email address or access to an Internet enabled PC to become a subscriber to this service.

In one embodiment of the invention for a prepaid user, the method may conditionally debit the user's prepaid account, and if the user subsequently views an advertisement, rebates the conditional debit. If the user does not, any conditional debit is finalized as a regular debit. In this embodiment the method would operate like a typical prepaid system (e.g. cut-off the service when credits are depleted), except that the debit would become permanent only if the user does not view a advertisement. In this way the service provider would bear no risk in extending credit to a user who has not agreed to be billed for non-subsidized calls.

In a preferred embodiment of the system, the mobile network provider/operator will identify and track the location of the terminal belonging to a user who has subscribed to have calls subsidized. When it is determined that the terminal is within a certain proximity to a client advertiser's place of business, the system may query the user information database to determine if the advertiser's service/product may be of interest to the user, and if so, store an advertisement of that advertiser in a queue for possible later transmission to the user. In another embodiment the system may use factors such as the day of the week, or time of day when the call is made, to select an advertisement. When the user chooses to make or receive a subsidized call, and view a advertisement immediately following the completion of the call, the system can select and transmit an advertisement based on the terminal's then location, or if no advertiser is proximate to the terminal at the time of completing the call, present an advertisement previously stored in the ad queue.

In another embodiment of the system, all calls made or received by a user will qualify for a potential subsidy; each call generates a hyperlink being emailed to the user, which may be followed to a website that is populated by advertisements. In another embodiment of the system, a ratio of advertisements sent to calls made, or minutes used might be chosen (e.g. 1 advertisement for each 5 minutes of talk time, or 1 advertisement for every 5 calls made or received). In this way, making/receiving a potentially subsidized call will require a minimum of actions by the user. In this embodiment the user may be queried to “opt-out” of any subsidy before making/receiving a call. In lieu of receiving a hyperlink via e-mail, the user may be provided with a service provider or sponsoring advertiser website at the time of signing up for the mobile service, and receive a unique PIN to login to the website following a call, to view an advertisement and earn a rebate. The user would receive the website address and PIN at the time of applying for the wireless service

In a preferred embodiment, for both prepaid and billed users, in order to qualify for a full rebate, the user will respond to at least one question after the viewing the advertisement to verify that the user viewed the advertisement in a meaningful way. In yet another embodiment, the user would have to view an advertisement within a fixed period following the call. In yet a further embodiment the amount rebated to a user's account would be dependent on how soon after the call did the user view an advertisement. In this embodiment, a user who viewed the advertisement shortly after call completion and before a fixed cut-off time, would earn a greater rebate than a user who viewed the same advertisement, at a later time after call completion and before a fixed cut-off time. The value of the rebate having an inverse relationship to the length of delay between a call ending and the time of a user viewing an advertisement.

In another embodiment, the system would transmit an advertisement while the user was talking, or immediately following the end of a call, to the user's terminal and play the advertisement on the mobile terminal as soon as the call ended. Alternatively, the terminal could begin to play a advertisement previously downloaded to the terminal at the end of the call. If the system determined that the user viewed the advertisement (e.g. by the response to a question at the completion of the advertisement) the system would then rebate at least a portion of the charge or debit for the call just made. In this embodiment there would be no need for the user to access an e-mail or website via a PC at a later time to earn a rebate.

In yet another embodiment of the system, a user will have to transactionally “opt-in” to have a call potentially subsidized. The user of a mobile phone can do this before making or receiving a call by depressing a physical key, or instead of, hitting “send” (or similar key), or in response to a system prompt to opt-in. In this embodiment upon opting in, the system will email a hyperlink to the user to follow to view at least one advertisement, or alternatively the user will have to login to a website having advertisements and view at least one advertisement to receive a call rebate

These and other features, aspects and embodiments of the invention will be described in more detail below.

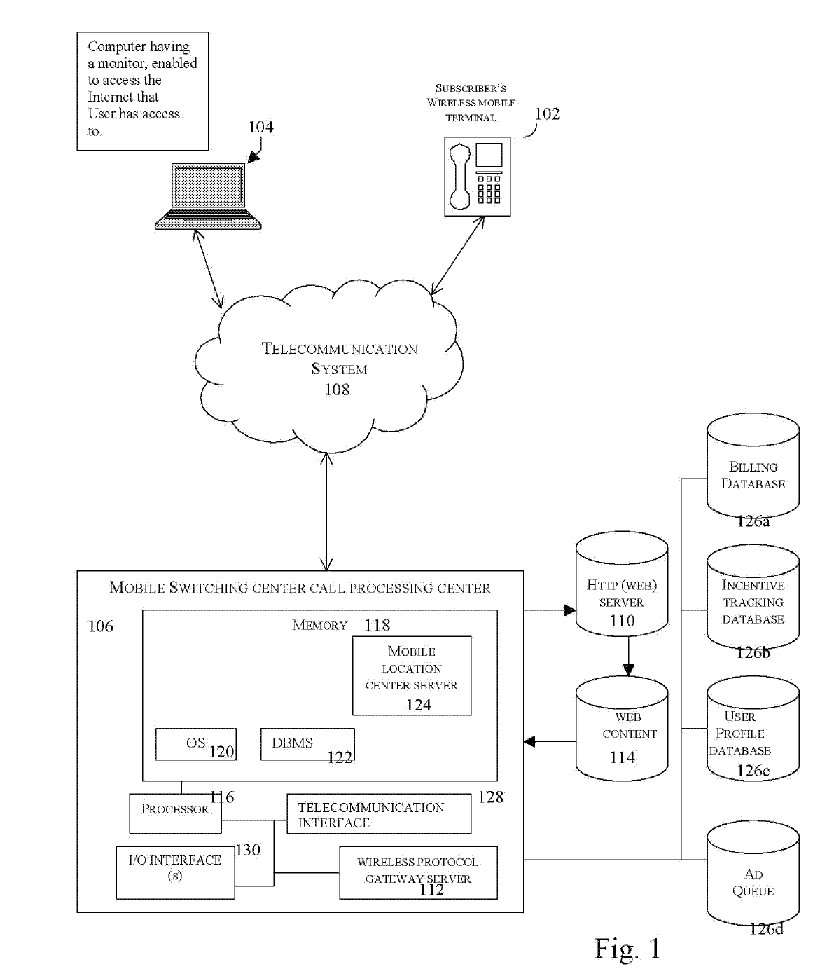

FIG. 1 is a block diagram illustrating an exemplary operating environment for implementation of certain embodiments of the present invention. The exemplary operating environment includes at least one wireless handset terminal 102 and one computer having a monitor (PC) 104 that is enabled to access the Internet, that the user has access to. The user's terminal 102 is preferably MS enabled. The user's terminal 102 includes a transceiver for an over the air interface such as GSM or CDMA to communicate with a Mobile Switching Center (MSC) call processing system 106. A telecommunication system 108 connects the user's phone 102 and the MSC 106, and the MSC 106 connects the user's terminal 102 to an HTTP (internet web) server 110 via a wireless protocol gateway server 112 in the MSC 106. The HTTP server 110 connects the user's terminal 102 to at least one website 114 containing downloadable advertising content. For purpose of illustration the wireless protocol gateway server 112 will be discussed in terms a of a “WAP gateway”, as it is the most common standard, but it is only meant to be an illustration and not meant to be a limitation, as the gateway can be any wireless protocol compatible with the phone service provider's network platform. Additionally, the telecommunication system 108 connects the PC 104 to the MSC 106, so that the user may receive a hyperlink emailed by the MSC 106, and follow it to a sponsor advertisement, or otherwise directly access a sponsor advertiser website 114 having an advertisement.

The telecommunication system 108 may be any public and or private communication network. In certain embodiments, the telecommunication system 108 is the Public Switched Telephone Network (PSTN). The telecommunication system 108 may include wired and or wireless (“3G”) segments and may carry digital and/or analog signals. In alternate embodiments, the telecommunication system 108 may take other forms, such as a voice over IP network or other types of data networks. The various components and functionality of typical telecommunication systems 108 are well known in the art and are therefore not reiterated herein.

The user's terminal 102 may be any wireless communication device that is configured to access web content 114 and interact with a telecommunication system 108. For example, the user's terminal 102 can be replaced or supplemented by other communication devices, such as wireless hand-held phone enabled computers (“Pocket PC”), wireless phone enabled personal digital assistants (“PDA”), digital phones, smart phones, etc., as may be appropriate. The internet enabled PC that the user has access to 104 may be any computer enabled to access the internet that also has a monitor (integrated or attached to the PC) to display websites.

In one embodiment, the MSC call processing system 106 is a processor-driven device or collection of devices that is configured for receiving and processing wireless terminal communications from, and initiating and transmitting wireless communications to, the user's wireless terminal 102. Further, the MSC call processing system 106 will link the user's terminal 102 through a WAP gateway 112 to an internet HTTP server 110 hosting a web page 114 having downloadable content. The MSC call processing system 106 may further be configured for accessing and reading associated computer-readable media having stored thereon data and/or computer-executable instructions for implementing the various methods of the present invention. In particular, a processor 116 for processing data and executing computer-executable instructions may drive the MSC call processing system 106. The MSC call processing system 106 also includes a memory 118, which may take the form of any computer-readable medium. The memory 118 may be logically and or physically divided into multiple units.

The memory 118 stores data and program modules, such as, for example, an operating system (“OS”) 120, a database management system (“DBMS”) 122, Mobile Location Center Server (MLCS) 124. These and or other programs may be executed by the MSC call processing system 106 to perform the various methods of the present invention. By way of example, the MLCS 124 may provide functionality for calculating the location of the user's terminal 102 by any location-finding scheme, such as GPS and select and transmit location specific advertising to the user's terminal 102.

Portions of the system such as the MSC call processing systems, MLCS, wireless protocols to access the Internet from mobile devices are well known in the art and are therefore not explained in detail herein. Those skilled in the art will appreciate that such functionality may be combined into fewer program modules or distributed among a greater number of modules than are illustrated in FIG. 1. In addition, such functionality may be distributed across multiple processor-driven devices, such as dedicated network servers, that collectively form the MSC call processing system 106.

The MSC call processing system 106 may include or be in communication with one or more databases. By way of illustration only, the MSC call processing system 106 may be in communication with a billing database 126a for storing payment information, an incentive tracking database 126b for calculating and storing the amount of rebate/credit the user has earned using the disclosed invention, during a billing cycle, a User Profile database 126c for storing the capabilities and settings of the users mobile terminal 102 as well as recording an user preferences (e.g. the types of advertisements the user may prefer as determined by the demographic/interest questionnaire the user completed as part of an application process), and an Ad queue 126d, for temporary storing of advertisements for later presentation. In a prepaid system embodiment, 126a could also monitor the amount of credit remaining in the user's account.

These and/or other databases may also store any other data used or generated by the MSC call processing system 106. Those skilled in the art will appreciate that the illustrated databases 126a-d may be physically and or logically separate from one another. For security, the MSC call processing system 106 may have a dedicated connection to the databases 126a-d, as shown. However, the MSC call processing system 106 may also communicate with one or more of the databases 126a-d via the telecommunication system 108 or other network.

The MSC call processing system 106 may communicate periodically with the HTTP server 110 to determine if there is any advertising content available. If advertising content 114 is found, the MSC call processing system 106 may query the User Profile 126c to compare the category of the advertising content to any preferences in the User Profile 126c. If a match is found, the MSC call processing system may then determine if there is any parameter to the advertising content (e.g. Advertiser requires that it be shown only in a certain area). If so, the MLCS 124 determines the location of the user's terminal 102 and compares this information with the parameter. If the user's terminal 102 is found to be within the advertiser's parameters, the MSC call processing system 106 temporarily stores (caches) the advertisement web page content 114 in the Ad queue 126d for later presentation. If the advertising content category does not match a preference in a user's User Profile 126c, or if the user's terminal 102 is not in the advertiser's parameters, the MSC call processing system 106 may not store an advertisement in the Ad queue 126d. Additionally, based on a time element, the Ad queue 126d may purge an advertisement if it is not presented within a fixed period. Caching of data and wireless messaging are well known in the art and not explained in detail herein.

Wireless communications calls may be received at the MSC call processing system 106 through a telecommunication interface 128. The telecommunication interface 128 may take the form of a telephony line card or other suitable hardware and/or software for connecting the MSC call processing system 106 to the telecommunication system 108 and providing the logical connection between the MSC call processing system 106 and a user's wireless terminal 102. The telecommunication interface 128 thus allows the user to interact with the MSC call processing system 106 by providing request commands (e.g. menu selection to access the internet) that can be interpreted by the MSC call-processing system 106. The MSC call-processing system 106 may be configured with additional and or other communication interfaces for providing logical connections to other types of communication devices and networks.

The MSC call processing system 106 may also include input/output (“I/O”) interface(s) 130 for providing logical connections to various I/O devices, such as a keyboard, a mouse, a microphone, a printer, a scanner, speakers, a display, etc. A system administrator may utilize these and other I/O devices to interact with the MSC call processing system 106. For example, a system administrator may interact with the MSC call processing center 106 to populate and edit the User Profile database 126c, download billing information from the billing database 126a, alter the parameters for the MLCS 124, etc. Those skilled in the art will appreciate that the MSC call processing system 106 may include alternate and or additional components, hardware or software.

Thus configured or similarly configured, the MSC call processing system 106 may provide the hardware and software to support the creation and maintenance of an interactive, location enabled, advertising, incentive based system associated with a user's account. In one embodiment the user may only download advertising content 114 from a website controlled by the service provider. The user having a WAP enabled terminal 102 types the address of a web site 114 he wishes to access by using the keypad. The micro browser then sends the request over the airwaves as a digital signal to a cell phone transmission tower, that relays it by landline to the MSC call processing center 106, having a wireless protocol gateway server “a WAP gateway” 112, whose software finds the HTTP server 110 and retrieves the specific web page content 114. The wireless protocol gateway server's 112 software encodes the HTTP data, from HTML (the common language of the Internet) to a wireless markup language (WML). The WML encoded data is sent to the user's terminal 102 to be displayed.

In another embodiment upon receipt of a request from the user's terminal 102 an advertising hyperlink will be emailed to the user, that he can access via a PC 104 that has Internet access. The user will follow this hyperlink to the advertising website 114, login, and view an advertisement. In another embodiment, the user will instead directly enter the Internet address of a sponsor advertiser's website on a PC 104 to view an advertisement. In certain embodiments viewing an advertisement will include responding to a question at the end of the advertisement being played to insure that the user viewed the advertisement. The incentive tracking database 126b will determine if the user viewed the advertisement and the billing database 126a will rebate a percentage (0-100%) of the charge/debit associated with the call. In another embodiment the user will be required to view an advertisement within a system administrator established time parameter to obtain a rebate.

In certain embodiments, all content retrieval, encoding, tracking, and transmission and verification services involving the user are handled by the telecommunication system 108, for example, by a participating wireless service provider phone company.

The call processing system 106 may track the user's terminal 102 while it is powered on, and periodically communicate with the Mobile Location Center Server (MLCS) 124 to determine if the user is in a “Sponsored Location”. A Sponsored Location is a cell (or Pico cell) that the Service Provider has contracted with an advertiser to present advertising in, via the described invention. The user's mobile terminal 102 may have “opt-in” and “opt-out” buttons, or similar keys, to request or avoid advertisement subsidies.

Those skilled in the art will appreciate that the operating environment shown in and described with respect to FIG. 1 is provided by way of example only. Numerous other operating environments, system architectures and device configurations are possible. For example, the MSC call processing center 106 may in certain embodiments be implemented at or within an existing telecommunications system. In other embodiments, various components of the PSTN may be adapted for performing the functionally described with respect to the present invention. Accordingly, the invention should not be construed as being limited to any particular operating environment, system architecture or device configuration.

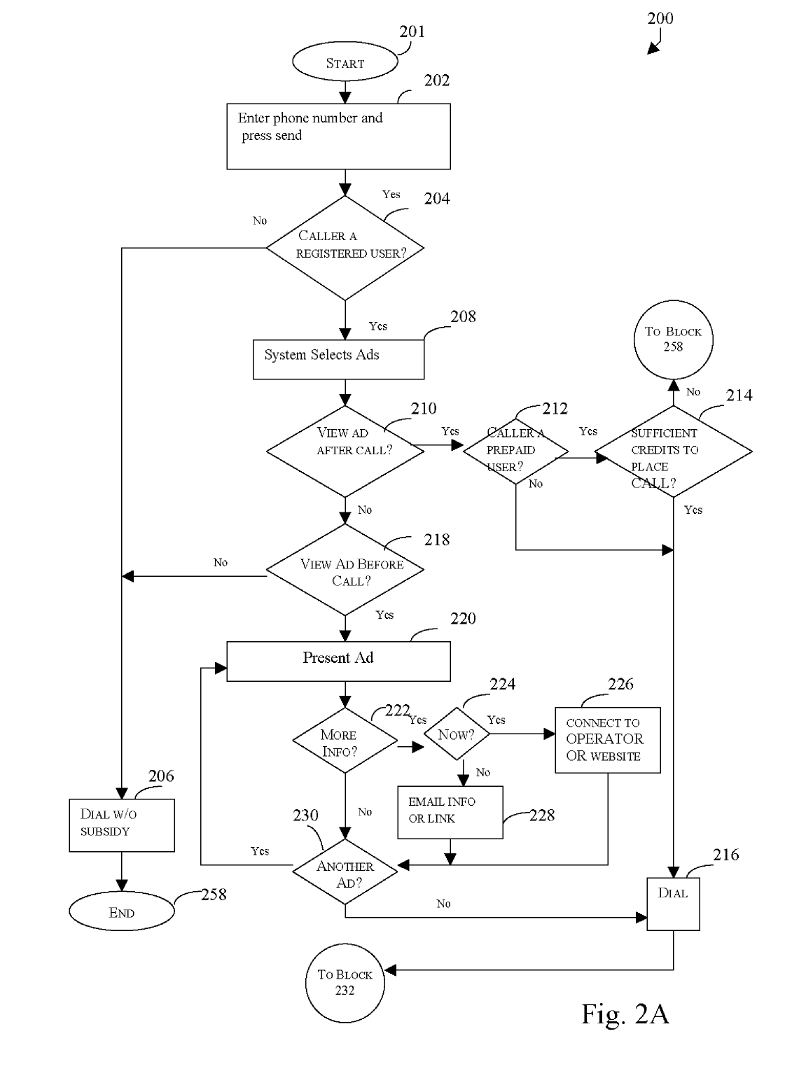

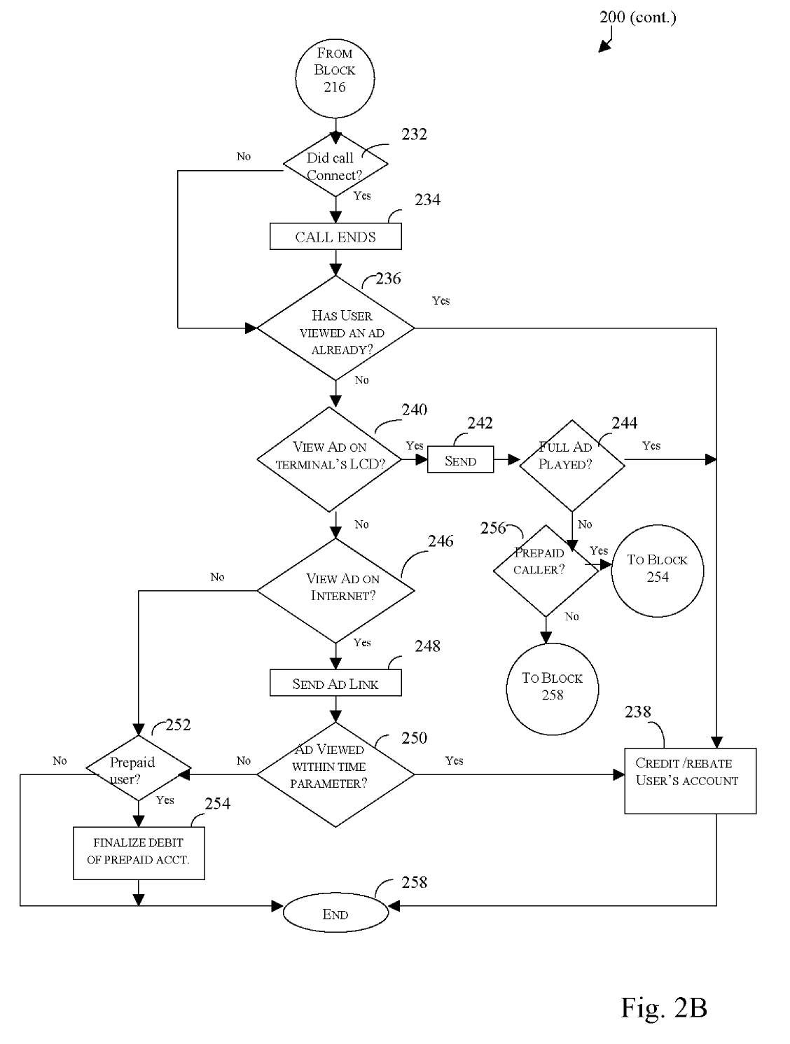

FIG. 2, comprising FIG. 2a and FIG. 2b, are flow diagrams illustrating an exemplary method for a user call session in accordance with certain embodiments of the invention. The method begins at starting block 201, which represents the normal operating state of a user's wireless mobile terminal 102 that is powered on, with good signal strength. The method, from time to time, has the MSC call processing system 106 query the MLCS 124 to determine whether or not the user's mobile wireless terminal 102 is in sponsored location. If it is determined that the user's mobile wireless terminal 102 is not in a sponsored location no action is taken. If the MSC call processing system 106 determines that the user's mobile wireless terminal 102 is in sponsored location, the MSC call processing system 106 queries the user profile database 126c and stages sponsor advertisements in the Ad queue 126d for possible later distribution. In one embodiment, an advertisement placed in the Ad queue 126d that is not presented within a time parameter (e.g. 1 hour after placement) established by the system administrator or sponsoring advertiser, will be purged.

At block 202 the user enters a phone number on his mobile phone 102 and presses a “send” key, or similar key used to initiate a call. While though the invention is illustrated as a call being made by a user, the present flowchart is easily modifiable by one skilled in the art to make Block 202 “user receives notice of an incoming call”, etc.

The method then proceeds to Block 204, where the system queries the User Profile Database 126c to determine if the user has registered for subsidized calls. In the case of a prepaid user, an additional query may be made to the billing database 126a to determine if sufficient account balance remains to pay for the call, as will be detailed below.

If the caller is not registered for subsidy service the call proceeds to Block 258 where number is dialed without a subsidy and the method ends. In other embodiments, the system may require that the user transactionally “Opt-In” to have a call potentially subsidized before any call. Yet in another embodiment, if the user is a subscriber who has registered for the service, all calls will generate a potential subsidy unless the user transactionally “Opts-Out”. If the user is registered for subsidized calls, the method proceeds to Block 208.

At block 208 the MSC 106 determines whether the user's terminal 102 is in a sponsored location. If so, the MSC 106 selects an advertisement for a local sponsor for presentation. If not, the MSC 106 selects an advertisement from the Ad queue 126d. In one embodiment a advertisement from the Ad Queue 126d will be chosen by first-in-first-out (FIFO). In another embodiment an advertisement from the Ad Queue 126d will be chosen by last-in-first-out (LIFO). In yet another embodiment, an advertisement from the Ad Queue 126d will be chosen by the highest advertiser bid.

The user is then queried at Block 210 if he will view an advertisement after the call is made. If the user responds in the affirmative (voice response, depressing a key, etc.) the method proceeds to Block 212 where it is determined whether the user is a “prepaid user” by querying the User Profile Database 126c. If the user is not a prepaid user, the system proceeds to Block 216 and dials the number entered. If the user is a prepaid user, the system proceeds to Block 214 where the system may query the billing database 126a and determine if a sufficient credit balance exists to make a call and “conditionally debit” the prepaid account for the call. If a sufficient credit balance exists to place a call the system proceeds to Block 216 and dials the number entered. If an insufficient credit balance exists the system proceeds to Block 258 and ends. Prepaid calling is well known in the by one skilled in the art and is not detailed further. If the user responds negatively at Block 210, the method proceeds to Block 218 and queries if the user will view an advertisement before making a call. In some embodiments, if the user does not respond at Block 210, the system may enter a default “no” to all further inquiries for the user, proceed to Block 206 and attempt to complete the call without a subsidy. If the user will not view an advertisement before a call, the method proceeds to Block 206 and attempts to complete the call without a subsidy. The method proceeds to Block 258 and ends. In some embodiments, if the user does not respond at Block 218, the method proceeds to Block 206 and attempts to complete the call without a subsidy.

If at Block 218 the user responds affirmatively the method proceeds to Block 220 and an advertisement is presented. At completion the user may then be queried at Block 222 if he wants more information regarding the advertiser/advertisement. If the user answers in the negative, the method then may query if he will view another advertisement at Block 230. If the user answers in the negative the method proceeds to Block 216 and dials the number entered. If at Block 222 the user responds in the affirmative the method proceeds to Block 224, where the user is asked if he wants that information now. If he responds in the negative the method proceeds to Block 228 and the MSC 106 emails a hyperlink to the user, that the user may later follow to access the requested additional information. If at Block 224 the user responds in the affirmative, the method proceeds to Block 226 where he may be connected to a website 114, or a live operator to access more information. Once the information session is terminated or no additional information is requested, the method proceeds to Block 230 and asks if the user will view another advertisement. If the user responds in the negative the method proceeds to Block 216 and the number entered is dialed. If the user responds in the affirmative, the method proceeds to Block 220 and another advertisement cycle begins. The advertisement presentation cycles through as detailed supra until the user declines further advertisements, whereupon the method proceeds to Block 216 and the number entered is dialed.

The method then proceeds to Block 232 where the method determines whether the call was connected. If the call is not connected, the method proceeds to Block 236 where it is determined whether the user has already viewed an advertisement. If the call did connect, the method proceeds to Block 234 where the call completes. The method then proceeds to Block 236 to determine if the user has already viewed an advertisement.

If the user has already viewed an advertisement the method proceeds to Block 238 where the MSC 106 rebates the user's account information on the Billing Database 126a, or credits any applicable incentive 126b. If at Block 236 it is determined that the User has not already viewed an advertisement the method proceeds to Block 240 where he is queried whether he will view an advertisement on his terminal's LCD. If the user responds in the negative, or does not respond (e.g. closes his clamshell phone, powers off the phone, etc.), the method may interpret this as a negative response, default “no” to all further inquiries, credit no subsidy (in the case of prepaid debit finalize any conditional debit as a regular debit on the prepaid account Block 254), and proceed to Block 258 to end.

If, at Block 240 the user responds in the affirmative, the method proceeds to Block 242 where an MMS advertisement, or a link to an advertisement site, is sent via a transport protocol (e.g. WAS) to a user's mobile terminal LCD. Wireless messaging is well known in the art and so is not further detailed. The method proceeds to Block 244 where it is determined whether the full advertisement is played. In one embodiment the user must have additionally responded to a question following the advertisement to qualify for any rebate/incentive. In yet another embodiment, the user must respond with a correct answer to a question following the advertisement to earn a rebate. If the full advertisement was not played, the method proceeds to Block 256 where it is determined if the caller is a prepaid user. If the user is not a prepaid user, the method proceeds to Block 258, where the method ends and the user receives no call subsidy. If the user is a prepaid user, the method proceeds to Block 254, where any conditional debit is finalized as a regular debit. The method proceeds to Block 258 and ends. If the Incentive Tracking Database 129b determines that a full advertisement is played, the method proceeds to Block 238 where the Billing Database 129a rebates the user's account the conditional debit or charge. The method proceeds to Block 258 where the method ends.

If at Block 240 the user responds in the negative, the method proceeds to Block 246 where he is asked if he will view an advertisement via an Internet enabled PC 104 at a later time. If the user does not respond, or responds in a way that the system interprets as a negative response (e.g. closes his clamshell phone, powers off the phone, etc.) the method may enter a default “no” to all further inquiries for the user, proceed to Block 252 where it is determined if the user is a prepaid user, and if so finalize any conditional debit into a regular debit at Block 254, and proceed to Block 258 to end. In the case of a billed account, the system will rebate no part of the charge for the call, and proceed to Block 258 to end.

If the user responds in the affirmative, the method emails the user a hyperlink Block 248 to the user, that the user may access via a PC 104 or his terminal 102, to later follow to a website 114, login, and view an advertisement. The method then proceeds to Block 250 where the Incentive Tracking Database 129b determines if the user has responded to the email hyperlink sent in Block 248, or logged into a service provider or sponsoring advertiser website, and viewed an advertisement. In a preferred embodiment the user will have to view the advertisement within a given time parameter (e.g. 12 hours following completion of the associated call) to earn a rebate. The user will use a unique login identification (PIN) that may be his phone number, or other alphanumerical combination selected by the user, or assigned to the user by the service provider. If it is determined that the user has viewed an advertisement the method proceeds to Block 238 where the Incentive Tracking Database 129b communicates this to the Billing Database 129a and the user's account is rebated any conditional debit or charge. The method proceeds to Block 258 where the method ends. If the user did not, the method proceeds to Block 252 where the Incentive Tracking Database 129b queries the User Profile 126c to determine if the user is a prepaid user. If the user is not a prepaid user, the method proceeds to Block 258, no subsidy is given, and the method ends. If the user is a prepaid user, the method proceeds to Block 254 where the Incentive Tracking Database 129b notifies the Billing Database 129a and finalizes any conditional debit as a regular debit. The method proceeds to Block 258 and ends. In another embodiment a user may still receive a partial rebate for viewing an advertisement, even if it is beyond any system administrator time parameter, or if the user log's into a service provider website, but does not answer a question, or answers a question incorrectly. In yet another embodiment, the value of the rebate will be inversely related to the length of time between call completion and viewing, until no rebate can be earned and the hyperlink becomes linked to an error message website page notifying the user that no rebate is available.

In another embodiment, at Block 236 if it is determined that the user has not yet viewed an advertisement, the system may first query the user if he will view an advertisement later via an internet enabled PC 104 at Block 246 (without a query of whether he will view an advertisement on his mobile terminal presently 240), and if the system receives a negative response, the system may attempt to immediately send and present an advertisement on the mobile terminal's LCD 102 Block 242. In some embodiments, the advertisement may have been previously downloaded onto the terminal. If the full advertisement is played Block 244 the user system will rebate any conditional debit/charge at Block 238. The method then ends at Block 258. In another embodiment, the user may have to respond to a question(s) at the conclusion of the advertisement to receive a credit or rebate. If the advertisement is interrupted by the user closing the phone, hitting button that signals the end of a call, etc., no subsidy will be given, or in the case of a prepaid user, any conditional debit is finalized as a regular debit Block 254.

As may be seen from the foregoing, the present invention provides systems and methods for providing a new revenue stream for participating phone companies and benefits to the user. The disclosed invention utilizes the factors of the user's estimated location, and user profile to select relevant (physically proximate/user interest) advertisements that can be viewed when convenient to the user. Likewise, the user receives the benefit of having a rebated call charge or debit.

It should be appreciated that the exemplary aspects and features of the present invention as described above are not intended to be interpreted as required or essential elements of the invention, unless explicitly stated as such. It should also be appreciated that the foregoing description of exemplary embodiments was provided by way of illustration only and that many other modifications, features, embodiments and operating environments are possible. Accordingly, the scope of the present invention should be limited only by the claims to follow.

I claim:

1. A method of providing advertisements to a prepaid user of a mobile terminal of a prepaid mobile communications system, comprising:
identifying the mobile terminal utilized by the prepaid user;
determining whether a sufficient credit balance exists on the prepaid user's account to make or receive a call;
if the account has the sufficient credit balance, prompting the prepaid user to choose to have the call subsidized by viewing an advertisement after the call;
if the prepaid user chooses to have the call subsidized, selecting an advertisement;
making or receiving the call; and
making the advertisement available to the user for viewing after the call.

2. A computer-readable medium having stored thereon computer-executable instructions for performing the method of claim 1.

3. The method of claim 1, wherein the mobile terminal has a liquid crystal display (LCD).

4. The method of claim 1, further comprising the prepaid user having access to an Internet enabled computer (PC).

5. The method of claim 4, wherein the PC is connected to a monitor.

6. The method of claim 1, wherein the selecting of the advertisement is based at least in part on one of a group of factors, comprising:
location of the mobile terminal at the time of the call,
day of the week at the location of the mobile terminal,
local time at the location of the mobile terminal,
the prepaid user's answers to a questionnaire regarding the user's interests, and
the prepaid user's answers to a questionnaire regarding the user's demographic information.

7. The method of claim 1, further comprising the prepaid mobile communication system conditionally debiting the prepaid user's account for the call, when the user selects to view an advertisement after the call.

8. The method of claim 7, wherein the prepaid mobile communication system rebates the conditional debit made to the prepaid user's account upon receipt of indicia indicative of the prepaid user having viewed the advertisement.

9. The method of claim 8, further comprising the prepaid user responding to at least one question at the completion of the advertisement.

10. The method of claim 8, wherein the amount rebated for viewing the promotional message decreases, as the time between the call and the viewing increases.

11. The method of claim 1, wherein the viewing availability of the advertisement is of a fixed duration following the call.

12. The method of claim 1, further comprising the advertisement being made viewable to the user via a group, comprising:
the mobile terminal's LCD;
a hyperlink emailed to the user that may be followed to an advertisement; and
a website having an advertisement.

13. The method of claim 12, wherein the website is maintained by the prepaid mobile communication system provider.

14. The method of claim 11, wherein the prepaid user enters a unique identifier to login to the website.

15. The method of claim 1, further comprising the receiving advertising revenue form an advertiser in exchange for the service of making the advertisement viewable to the user.

16. A method of providing an advertisement to a user of a mobile terminal of a mobile communications system, comprising:
identifying the mobile terminal utilized by said user;
prompting the user to choose to have a call subsidized by viewing an advertisement after the call is made or received by the user;
if the user chooses to subsidize the call, selecting the advertisement;
making or receiving the call; and
making the advertisement available to the user for viewing after the call.

17. A computer-readable medium having stored thereon computer-executable instructions for performing the method of claim 16.

18. The method of claim 16, further comprising the mobile communication system conditionally charging the user's account for the call, if the user selects to view an advertisement after the call is made or received.

19. The method of claim 18, further comprising the mobile communication system rebating the conditional charge upon the user viewing the advertisement.

20. The method of claim 19, wherein the amount rebated for viewing the promotional message decreases, as the time between the call and the viewing increases.

21. The method of claim 19, further comprising the user responding to at least one question at the completion of the advertisement.

22. The method of claim 16, wherein the viewing availability of the advertisement is of a fixed duration.

23. The method of claim 16, wherein the selecting of the advertisement is based at least in part on one of a group of factors, comprising:
location of the mobile terminal at the time of the user's response,
day of the week at the location of the mobile terminal,
the local time at the location of the mobile terminal,
the user's answers to a questionnaire regarding the user's interests, and
the user's answers to a questionnaire regarding the user's demographic information.

24. The method of claim 16, wherein the advertisement is made viewable by the user via a group, comprising:
the mobile terminal's LCD;
a hyperlink emailed to the user that may be followed to an advertisement; and
a website having an advertisement.

25. The method of claim 24, wherein the website is maintained by the mobile communication system provider.

26. The method of claim 24, further comprising a sponsoring advertiser paying the mobile communication system provider for making the advertisement viewable by a user.

27. The method of claim 24, further comprising the user entering a unique identifier to login to the website.

28. A system for providing subsidized calls to a user of a mobile terminal, the system comprising:
means for identifying a mobile terminal of a user;
means for providing said user an option to view an advertisement after a call is made or received by said user;
if the user chooses to view an advertisement after the call, means for selecting the advertisement;
means for conditionally charging the user's mobile account for the call;
means for making the advertisement available for viewing by the user after the call;
means for receiving data indicative of whether the user views the advertisement;
means for storing said data; and
means for rebating the user's mobile account based on said data.

29. The system of claim 28, further comprising a means for selecting the advertisement based at least in part, on one of a group of factors, comprising:
the location of the mobile terminal at the time of the user's response,
the day of the week at the location of the mobile terminal,
the local time at the location of the mobile terminal,
the user's answers to a questionnaire regarding the user's interests, and
the user's answers to a questionnaire regarding the user's demographic information.

30. The system of claim 28, wherein the means for making the advertisement available for viewing by the user after the call is made, comprises:
the mobile terminal's LCD;
a hyperlink emailed to the user that may be followed to an advertisement; and
a website.

31. The system of claim 28, further comprising:
means for determining the amount to be rebated to the user's mobile account based at least in part on the amount of time that has lapsed between the completion of the call and the receipt of data indicative of viewing.

32. A system for providing subsidized calls to a user of a mobile terminal, the system comprising:
a server configured to:
identify a mobile terminal of said user;
provide said user an option to view an advertisement after a call is made or received by said user;
if the user chooses to view an advertisement, select the advertisement;
conditionally charge the user's mobile account for the call;
provide said user the advertisement after the call;
rebate the user's mobile account based on a receipt of data indicative of viewing; and
a database configured to receive and store data indicative of whether the user views the advertisement.

33. The system of claim 32, wherein the stored data comprises the data identifying the user of the mobile terminal.

34. The system of claim 32, wherein the storing of data indicative of viewing an advertising comprises the data identifying the user of the mobile terminal.

35. The system of claim 32, wherein the advertisement is provided to the user via a group, comprising:
the mobile terminal's LCD;
a hyperlink emailed to the user that may be followed to an advertisement; and
a website having an advertisement.
